(19) United States
(12) Patent Application Publication
(10) Pub. No.: US 2024/0206021 A1
(43) Pub. Date: Jun. 20, 2024

(54) METHOD OF CONTROLLING A SWITCHING CONVERTER AND RELATED SWITCHING CONVERTER

(71) Applicant: WHIRLPOOL CORPORATION, BENTON HARBOR, MI (US)

(72) Inventors: Salvatore Baldo, Varese (IT); Mario Barbati, Varese (IT); Andrea Gallivanoni, Sempione (IT); Silvio Sperone, Tortora (IT)

(73) Assignee: WHIRLPOOL CORPORATION, BENTON HARBOR, MI (US)

(21) Appl. No.: 18/539,818

(22) Filed: Dec. 14, 2023

(30) Foreign Application Priority Data
Dec. 14, 2022 (EP) 22213623.6

(51) Int. Cl. H05B 6/04; H02M 1/00; H02M 7/48; H02M 7/5387; H05B 6/06

(52) U.S. Cl. CPC H05B 6/04; H02M 1/0058; H02M 7/4815; H02M 7/5387; H05B 6/065

(57) ABSTRACT

A method of controlling a switching includes a regulating the output power to be delivered to the at least one resonant load, adjusting a common switching frequency of all PWM control signals sent to a plurality of switches and the phase displacement of all said PWM control signals by adjusting a time delay between turning-on of diagonal switches of said two half-bridge switching stages connecting said resonant load within the same switching period. The phase displacement is carried out until hard-switching working conditions for said half-bridge switching stages are met, and when said hard switching working conditions are met, the common switching frequency of all said PWM control signals are adjusted to prevent hard-switching working conditions.

### CROSS-REFERENCE TO RELATED APPLICATIONS

This application claims priority to European Patent Application No. 22213623.6, filed on Dec. 14, 2022, entitled, “METHOD OF CONTROLLING A SWITCHING CONVERTER AND RELATED SWITCHING CONVERTER,” the disclosure to which is hereby incorporated herein by reference in its entirety.

### TECHNICAL FIELD

The present disclosure relates to power converters and more specifically, to methods of controlling a switching converter, usable in connection with induction cooktops, for induction heating items of cookware placed above a heating coil and related switching converters.

### BACKGROUND OF THE DISCLOSURE

Cooking appliances, in particular induction cooking appliances, have at least one main switching converter to supply induction heating elements with a regulated supply power generated from a main energy supply, and an energy storage unit, in particular a bus capacitor, provided for smoothing bus voltage variations by charging/discharging a capacitor. Switching converters may be used as AC current generators (inverters) for induction cooktops, for powering heating coils magnetically coupled with pots/pans.

Usually, the inverter topologies are resonant half bridge or single ended quasi-resonant. Quasi-resonant converters are the cheapest and are widely used, especially in single coil cooktops. However, these converters are very complex to control and, due to the high working voltages, they are subject to high rate of device failure/damage. Moreover, the controllability range of the power on the pan is very narrow, forcing the inverter to work in ON/OFF mode in case low power levels are requested by the user. Half bridge converters are the most diffused, especially in multi-coil cooktops. Compared to quasi-resonant, they are more robust and easier to control. Although the controllability range of the output power is larger than a quasi resonant, these inverters are also forced to work in ON/OFF mode for low power values. Furthermore, when a low-quality pan is used, the current circulating in the inverter is high, greatly lowering the efficiency.

One possibility to improve the efficiency, by decreasing the circulating current, is to use full bridge inverters, such as the one shown in FIG. 1, where the number of switching devices doubles but each switching device may be smaller and less expensive. FIGS. 2A, 2B and 2C show the full bridge converter of FIG. 1 in different working configurations. The full bridge converter consists of two half-bridge legs S1-S2, S3-S4, each of which comprises two switching devices. A load is connected between the two intermediate nodes of each leg, as shown in FIG. 2A. In normal operation, the switching devices in a full bridge topology are switched ON and OFF in a specific pattern. Referring to FIG. 2A, S1 and S2 will never be activated at the same time, and similarly S3 and S4 will never be activated at the same time, otherwise a short-circuit would be created. On the other hand, switching devices that are located diagonally in different legs are activated at the same time to have current flowing through the load.

Referring to FIG. 2B, S1 and S4 will be turned on at the same time to have current flow through the load; after a predetermined amount of time, S1 and S4 are turned off, and S2 and S3 are turned on, as shown in FIG. 2C. This way, the current through the load will flow in the opposite direction as before, thus creating an alternating current through the load at a frequency corresponding to the switching frequency of the devices.

In induction cooktops, typically the load is a series resonant circuit composed of a resonant capacitor and an inductor, and the inductor represents the induction coil and the pot placed on the cooktop surface above it.

A typical driving of a full bridge inverter is shown in FIG. 3. For this example, a full-bridge converter has been simulated at 230 VAC, with a load composed of an inductance of 80 pH and a resistance of 10Ω, with a resonant capacitor of 66 nF. The depicted signals in FIG. 3 represent the gate signals of the switches S1, S2, S3 and S4. When the signals are at the high level (about 15 V) it means that the devices are in ON state, while when the signals are at zero voltage it means that the devices are in OFF state.

The square-wave signal at the bottom of the plots in FIG. 3 represents the voltage between the switching nodes of the inverter (voltage across nodes M and F1 as shown in FIG. 1) while the sinusoidal signal is the current through the load.

A method of driving the switches of the full-bridge inverter of FIG. 2 and allowing to control the power delivered to the load is called phase shift (PS) control mode, and consists in introducing a switch-on delay between the switches placed diagonally in the full-bridge topology, i.e., the pairs S1-S4 and S2-S3, whilst switching in phase-opposition the switches belonging to a same half-bridge, i.e., the pairs S1-S2 and S3-S4.

In the case shown in FIG. 3, the driving is at zero phase displacement, because the time-interval of overlap between the ON states of devices S1 and S4 (or S2 and S3) is 100%, obtaining the maximum power transfer on the load. For this particular case, the current peak is about 35 A.

FIG. 4 shows the driving of the same system, at the same frequency, with a phase displacement PS of 50%, because the period of overlap between the ON states of devices S1 and S4 (or S2 and S3) is 50%. In this case, the current on the load decreases (peak about 23 A), effectively obtaining a power variation on the load. In this example, device S1 is lagging S4 (or S2 is lagging S3), i.e., is activated at a later time during a switching period, but the phase displacement is also obtained in reverse, with device S1 leading S4 (or S2 leading S3).

Using the same values of parameters for the time graph of FIG. 4, FIG. 5 shows a graph of the power transferred to the load vs the percentage of phase displacement variation, i.e., the percentage of overlap between the control signals of the devices diagonally, for a fixed switching frequency of the devices (81 kHz in the case of FIG. 4). Based on the circuits, type of switches, using of snubber across the switches etc., the complete variation of phase displacement from 0 to 100%, keeping the frequency fixed, could lead to not working in soft switching mode, i.e., hard switching conditions working mode, a condition in which the switching of the devices occurs in the presence of voltage and current other than zero, leading to high power dissipations. In particular, hard switching can occur if we want to deliver low power where, referring to the previous example, it may be necessary to have phase displacement of more than 50%.

The full-bridge topology of FIG. 1 may also be used to operate as a half-bridge converter. As shown in FIG. 6, that depicts a full-bridge inverter driving an inductive load with a resonance capacitor, a first half-bridge MASTER is switched according to a PWM modulation, the low side switch S4 of the second half-bridge S3-S4 FOLLOW is always kept on and the high-side switch S3 of the second half-bridge S3-S4 is always kept off. In this way, a series resonant half bridge inverter is obtained. Because the coil is designed to work with the voltage supplied by a full bridge, the advantage of using this technique is that the working voltage of the half bridge is halved and therefore it is possible to obtain low power values continuously, without resorting to ON/OFF operation.

FIG. 7 shows the power-to-frequency relationship of the inverter of FIG. 6 in the two cases:
case in which the master half bridge and one of the secondary ones are operated in PWM, so as to obtain the full bridge structure (upper curve);
case in which the master half bridge and the low side of one of the secondary ones are switched on, so as to obtain a half bridge structure (lower curve).

In both cases, the switching frequency is the only control variable used to adjust the output power. Thanks to this mode of operation, it is possible to extend the power regulation range. In fact, referring to the FIG. 7, with using the full-bridge configuration it is possible to supply an output power ranging from about 3400 W down to about 900 W, whilst with the half-bridge functioning condition illustrated in FIG. 6 it is possible to regulate the output power from 900 W up to about 150 W. Even in this case, it is not possible to work in soft switching conditions when smaller output power than 150 W are to be delivered to the load.

Therefore, the problem of reducing the output power provided to the load below a nominal minimum value without resorting to a discontinuous operation mode or a hard switching of the switches of the full-bridge is still unsolved. This problem is worsened when more than one induction heating coil is to be powered, because all heating coils must be powered at the same switching frequency for preventing generation of an annoying audible noise.

It is, thus, desirable to have a method of driving a full-bridge inverter, to generate a very small output power without forcing hard-switching of the switches of the full-bridge converter.

### SUMMARY OF THE DISCLOSURE

Tests carried out by the Applicant have shown that it is possible to regulate the output power provided to a resonant load supplied by a full-bridge inverter by adjusting the switching frequency and/or the phase displacement of the switches, whilst keeping all the switches in soft switching condition.

In further detail, according to the method of controlling a switching converter of this disclosure, the regulation of the output power to be delivered to the at least one resonant load is obtained by adjusting the common switching frequency of said PWM control signals and the phase displacement of said PWM control signals, wherein said step of adjusting the phase displacement is carried out by adjusting a time delay between the turning-on of diagonal switches of said two half-bridge switching stages connecting said resonant load, within the same switching period. The phase displacement is carried out until hard-switching working conditions for said half-bridge switching stages are met, and wherein when said hard switching working conditions are met the method further comprises the step of adjusting the common switching frequency of all said PWM control signals to prevent the hard-switching working conditions.

The control method of this disclosure is particularly suitable for being used in multi-stage switching converters according to this disclosure, comprising more than three half-bridge switching stages.

An induction hob comprising a switching converter of this disclosure and a method of controlling an induction hob comprising a switching converter are also disclosed.

According to one aspect of the present disclosure, a method of controlling an induction hob includes operating a switching converter within the induction hob. The switching converter includes a plurality of half-bridge switching stages connected electrically in parallel between a high-side line and a low-side line of a direct-current voltage supply within the switching converter. Each half-bridge switching stage of the plurality of half-bridge switching stages comprises a respective high-side controlled switch and low-side controlled switch connected in series between them and sharing an intermediate current terminal of the half-bridge switching stage. At least a first L-C resonant pair is connected between two intermediate current terminals of two half-bridge switching stages of the plurality of half-bridge switching stages. The first L-C resonant pair is configured to be magnetically coupled with a respective load, thereby defining at least a first equivalent resonant load (R-L-C). Operating the switching converter includes operating a first of the plurality of half-bridge switching stages as a master half-bridge switching stage and operating at least a second of the plurality half-bridge switching stages as a first slave half-bridge switching stage. The controlled switches of the half-bridge switching stages are turned on and off during switching periods by means of respective periodic pulse-width modulation control signals. A first L-C resonant pair of the at least one L-C resonant pair is connectable between the intermediate current terminal of the master half-bridge switching stage and the intermediate current terminal of the first slave half-bridge switching stage, and the first L-C resonant pair of the at least one L-C resonant pair is magnetically coupled with a first respective load, thereby defining a first resonant load (RLC1) of the at least one resonant load (RLC). The method further includes regulating a requested output power to be delivered to the at least a first resonant load with a first nominal reference value, including adjusting a common switching frequency of all the pulse-width modulation control signals and a phase displacement of at least one of the pulse-width modulation control signals. Adjusting the phase displacement is carried out by adjusting a time delay between respective turning-on instants of the high-side switches and the low-side switches of the master half-bridge switching stage and the low-side switches and the high-side switches of the slave half-bridge switching stage configured to supply the first resonant load within the switching periods. Adjusting the phase displacement is further carried out in a range between 0° and 180°, until hard-switching working conditions for the half-bridge switching stages are met, and, when the hard-switching working conditions are met, the common switching frequency of all the pulse-width modulation control signals are further adjusted to prevent the hard-switching working conditions.

According to another aspect of the present disclosure, the method of controlling a switching converter of this disclosure, the regulation of the output power to be delivered to the at least one resonant load is obtained by adjusting the common switching frequency of said PWM control signals and the phase displacement of said PWM control signals, wherein said step of adjusting the phase displacement is carried out by adjusting a time delay between the turning-on of diagonal switches of said two half-bridge switching stages connecting said resonant load, within the same switching period. The phase displacement is carried out until hard-switching working conditions for said half-bridge switching stages are met, and wherein when said hard switching working conditions are met the method further comprises the step of adjusting the common switching frequency of all said PWM control signals to prevent the hard-switching working conditions.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 shows a typical architecture of a full bridge inverter, suitable to be used in an induction heating cooktop.

FIGS. 2A, 2B and 2C show the full bridge stage of FIG. 1 in different working configurations.

FIG. 3 shows a typical time graph of the main signals of the full bridge inverter of FIG. 1, driven without phase-shift.

FIG. 4 shows a typical time graph of the main signals of the full bridge inverter of FIG. 1, with a phase displacement PS of 50%.

FIG. 5 shows a graph of the power transferred to the load vs. the percentage PS of phase displacement variation for a fixed switching frequency of the switches.

FIG. 6 depicts a full-bridge inverter of FIG. 1 driving a resonant load, wherein the second half-bridge FOLLOW is configured to allow the full-bridge inverter to operate as a series resonant half bridge inverter.

FIG. 7 shows a graph of the power transferred to the load vs. switching frequency, respectively when the half-bridges are switched for obtaining a full bridge functioning mode (upper curve) and when only one of the half bridge stages is switched for obtaining a half bridge working mode (lower curve).

FIG. 8 is a graph for comparing a possible power-to-frequency relationship for the inverter of FIG. 1, with and without phase displacement modulation.

FIG. 9 shows a multi-stage full bridge inverter comprising a single master half-bridge switching stage and a plurality of slave half-bridge switching stage, each configured to supply a respective resonant load.

FIG. 10 shows how to supply two loads electrically in series using the multi-stage full bridge inverter of FIG. 9.

FIG. 11 shows how to supply two or more loads electrically in parallel using the multi-stage full bridge inverter of FIG. 9.

FIG. 12 shows a multi-stage full bridge inverter comprising a plurality of master half-bridge switching stages and, for each master half-bridge switching stage, a respective second plurality of slave half-bridge switching stages.

FIG. 13 shows a multi-stage full bridge inverter comprising a plurality of master half-bridge switching stages for supplying numerous L-C resonant pair, wherein each L-C resonant pair is connected according to a matrix arrangement between a master half-bridge switching stage and a slave half-bridge switching stage of the second plurality.

### DETAILED DESCRIPTION

The present illustrated embodiments reside primarily in combinations of method steps and apparatus components related to a power converter. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

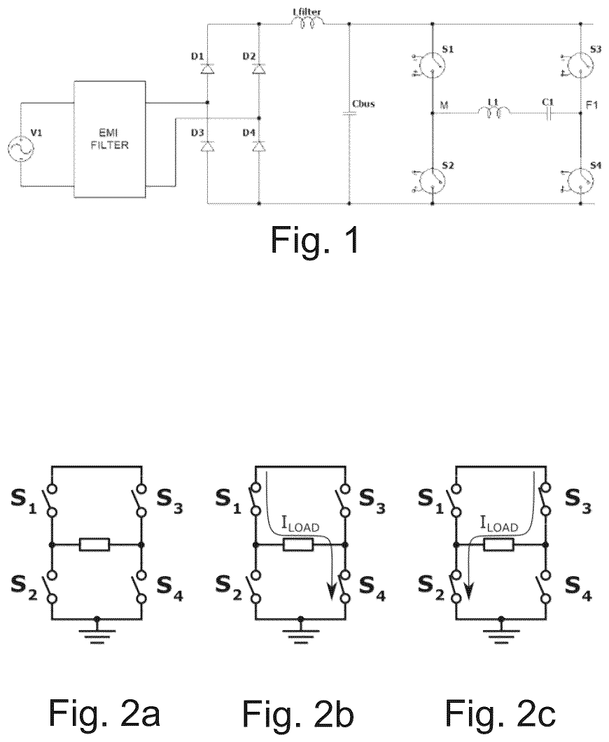

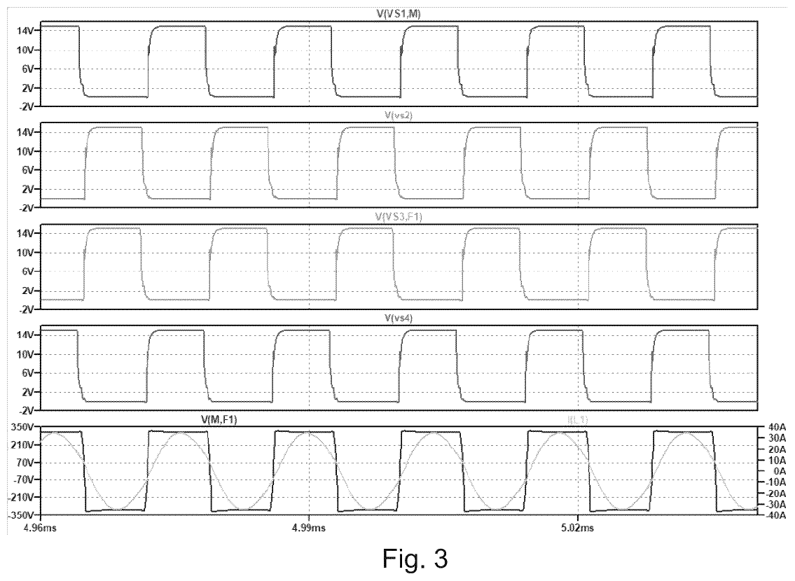

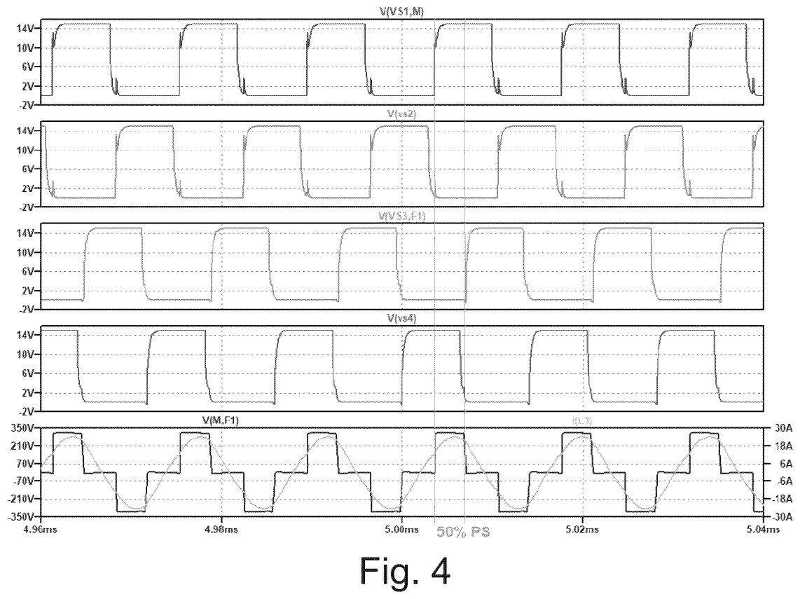

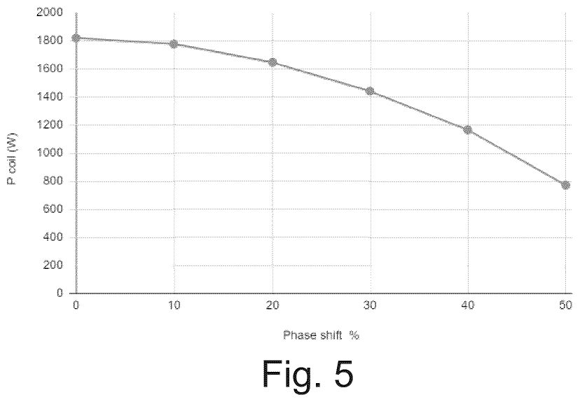

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Ordinal modifiers (i.e., “first”, “second”, etc.) may be used to distinguish between various structures of a disclosed article in various contexts, but such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about”, “approximately”, or “substantially” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

The invention disclosed herein is further summarized in the following paragraphs and is further characterized by combinations of any and all of the various aspects described therein.

The method of this disclosure will be illustrated, making reference to the enclosed FIGS. from 8 to 13. It may be used to control a switching converter, as the one shown in FIG. 1, which can be incorporated into an induction hob.

A rectifier stage, such as for example the diode bridge D1 to D4 shown in FIG. 1 preceded by an electromagnetic interference filter EMI FILTER having input AC terminals, for receiving an AC voltage to be rectified, and a DC-bus having a high-side line for making available a DC voltage between said high-side line and said low-side line, wherein the DC voltage is generated as a rectified replica of the AC voltage received at the input AC terminals.

At least one L-C resonant pair is connected between two intermediate current terminals of two half-bridge switching stages of the half-bridge switching stages, wherein the L-C resonant pair being configured to be magnetically coupled with a respective load thereby defining at least one equivalent resonant load R-L-C.

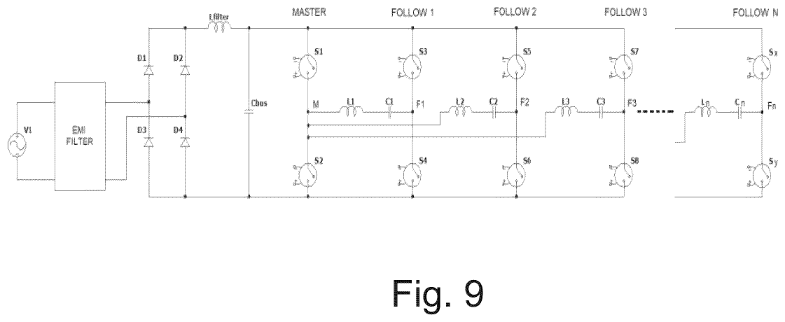

A control unit configured to turn on and off the controlled switches of the half-bridge switching stages during switching periods by means of respective periodic PWM control signals. The method that will be described hereinafter may be implemented in a multi-stage inverter, in which there is a master half bridge switching stage and many slave half bridge switching stages that will be activated depending on the coil to be energized, as shown in FIGS. 9 to 13. The master half bridge switching stage is then operatively combined with each of the slave half-bridge switching stages to constitute a full bridge inverter.

It has been found that it is possible to drive the switches of a full-bridge inverter in soft switching condition down to an almost null output power delivered to the supplied L-C resonant pair(s), by adjusting at the same time a common switching frequency of all the PWM control signals and the phase displacement of the PWM control signals. The phase displacement is adjusted by adjusting a time delay between turning-on instants of high-side/low-side switches of the master half-bridge switching stage and low-side/high-side switches, respectively, of the slave half-bridge switching stage configured to supply said first resonant load, within the switching periods.

According to an aspect, the step of adjusting the phase displacement is carried out until hard-switching working conditions for the half-bridge switching stages are met and, when the hard-switching working conditions are met, the step of adjusting the common switching frequency of all the PWM control signals is carried out to prevent the hard-switching working conditions.

According to an aspect, the step of adjusting the phase displacement includes a preliminary step of mapping levels of the output power as a function of the phase displacement about the first nominal reference power value, thereby defining an operating phase range. For example, the adjustment step may include changing the phase displacement within the operating phase range with a variation step in the range between 0.1° and 5°, preferably about 2°.

Therefore, using the method of the present disclosure it is possible to modulate the output power delivered to the supplied R-L-C load(s) down to very low power values without having to resort to the ON/OFF mode, thus preventing generation of the annoying clicking noise inherent in this mode of operation.

As shown in FIG. 8, by adjusting in a combined manner phase-shift PS and switching frequency, it is possible to regulate the output power in a wide regulation range with a high conversion efficiency. In this way, large power variations may be obtained in a limited frequency range adjustment, or it is possible to obtain very low power values without driving the inverter into a discontinuous functioning (ON/OFF) mode.

According to one aspect, paired values of adjustments of switching frequency and phase displacement PS of the control signals of the switches of the switching stages, may be preliminarily stored in a look-up table and the adjustments of the switching frequency and phase displacement are determined using as entries the requested output power to be delivered to the supplied R-L-C load(s) and electrical parameters of the R-L-C load(s), to drive all the involved switching stages of the inverter in a soft switching working condition. As an alternative, these paired values may be calculated with a control algorithm, for adjusting at the same time the switching frequency and the phase displacement so that a desired adjustment of power delivery is obtained, in function of the requested output power to be delivered to the supplied R-L-C load(s) and of the electrical parameters of the R-L-C resonant load(s).

According to one aspect, when the first nominal reference value is lower than a first predetermined power level, the method comprises energizing the supplied resonant load only by operating the master half-bridge switching stage whilst, in the slave half-bridge switching stage, the high-side controlled switch is maintained off and the low-side controlled switch is maintained on during the switching periods. The above-illustrated method steps may be implemented also in a switching converter comprising a second slave half-bridge switching stage with a second L-C resonant pair, configured to be magnetically coupled with a second respective load thereby defining a second resonant load R-L-C-2, connected between the intermediate current terminal of the master half-bridge switching stage and the intermediate current terminal of the second slave half-bridge switching stage. Conveniently, the control unit is configured to regulate a requested output power to be delivered the first resonant load to the first nominal reference value and to regulate a requested output power to be delivered the second resonant load to a second nominal reference value.

According to one aspect, it is possible to operate the master half-bridge switching stage to simultaneously energize the first resonant load R-L-C-1 and the second resonant load R-L-C-2.

According to one aspect, when the first nominal reference value and the second nominal value are set equal to each other and are lower than a second predetermined power level, the resonant loads R-L-C-1 and R-L-C-2 are energized only by operating the master half-bridge switching stage, while keeping off the high-side controlled switches of the first and second slave half-bridge switching stages and while keeping on during the switching periods the low-side controlled switches of the first and second slave half-bridge switching stages.

According to one aspect, the first predetermined power level and optionally also the second predetermined power level are lower than 900 W, preferably lower than 600 W, more preferably lower than 400 W. According to an option, the first predetermined power level is preferably equal to the second predetermined power level.

The present method may be implemented for controlling a multi-stage inverter of FIG. 9, which comprises a half bridge stage called MASTER, which has the role of master, and a plurality of slave half bridge stages called FOLLOW, each connected to a respective L-C resonant pair to be supplied. For example, if there are four coils and the second coil is to be powered, then the master half-bridge MASTER and the respective slave half bridge FOLLOW connected to the second coil may be activated, so as to obtain a full bridge structure for powering that L-C pair.

For example, if the first coil is also to be powered, there will be an algorithm that will cyclically switch on the inverter of FIG. 9 according to a sequence which could be: MASTER-FOLLOW1, MASTER-FOLLOW2, MASTER-FOLLOW1 and so on. Another possibility is to switch on more than one slave half-bridge at the same time, but in this case the master half-bridge MASTER must be able to supply the required power. Of course, the maximum number of half-bridge stages that can be turned on simultaneously is also limited by the maximum power from the mains line.

The architecture of FIG. 9 may be conveniently used to produce an induction cooktop allowing numerous ways to modulate the power delivered to a pot placed on the cooktop. Every time the master half-bridge MASTER and one of the slave half-bridge FOLLOW are turned on, a series resonant full bridge inverter is obtained. In this case, the classic way to modulate the power on the pot is to vary the driving frequency of the full bridge. However, in cases where several coils are turned on at the same time, the constraint of keeping the same switching frequency, necessary to avoid generating annoying hearable beating noises, can limit power management possibilities. To solve this problem, the full bridge structure gives us the possibility to use the method according to the present disclosure for adjusting phase displacement in combination with adjustment of the switching frequency, with which it is possible to modulate the power down to an almost null value.

According to one aspect, the supplied resonant pair(s) is/are configured to be controllably connectable between the two intermediate current terminals of two half-bridge switching stages. According to one aspect, the switching devices could be IGBT, MOSFET, SIC, GAN and others.

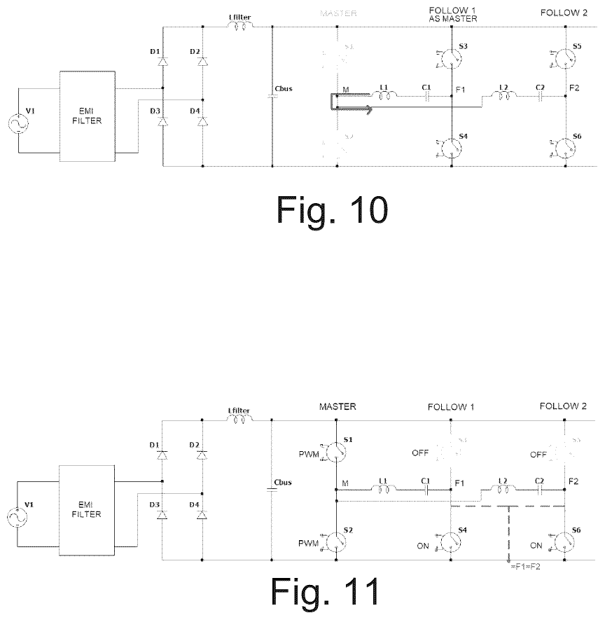

The method of this disclosure combines phase displacement adjustment and switching frequency adjustment so as to always find the right compromise in terms of power delivery, dissipated power and acoustic noise, especially in cases where more than one coil must be switched on. There are cases in which it may be useful to connect two coils together, as shown in FIG. 10, for example, when power is to be supplied to a very large pot that covers two coils. With the system in FIG. 9 it is possible to connect two coils in series using one of the secondary half bridges as master, as shown by way of example in FIG. 10. For example, if coil 1 and coil 2 must be connected in series, the first slave half bridge FOLLOW1 may be used as the master half-bridge and the second slave half bridge FOLLOW2 may be used as slave. Obviously, the opposite operation is also possible, i.e., using FOLLOW2 as master half-bridge and FOLLOW1 as slave half-bridge.

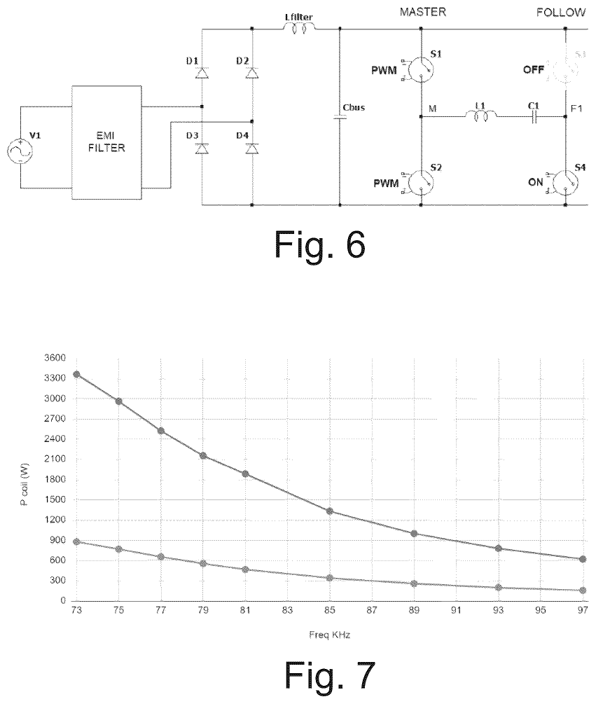

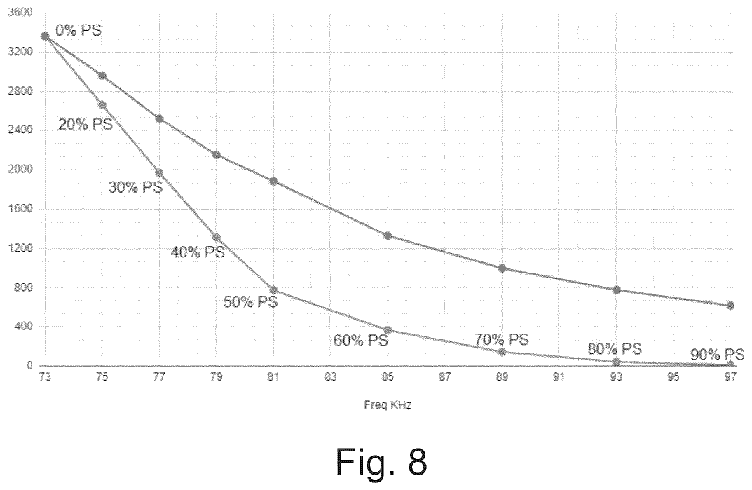

When operating the converter in a half-bridge configuration, as described earlier, and shown in FIG. 6, it is also possible to connect two or more coils in parallel, as shown in FIG. 11, using the master half bridge MASTER and the low side switches S4, S6, of the other slave half-bridges to select which coils are to be connected electrically in parallel. For example, if we want to connect coil 1 and coil 2 in parallel as shown in FIG. 11, it is sufficient to keep on the low side switches S4, S6 of the first and second slave half bridge (S4 and S6 in this example) FOLLOW1 and FOLLOW2 and operate the master half bridge MASTER at the driving frequency.

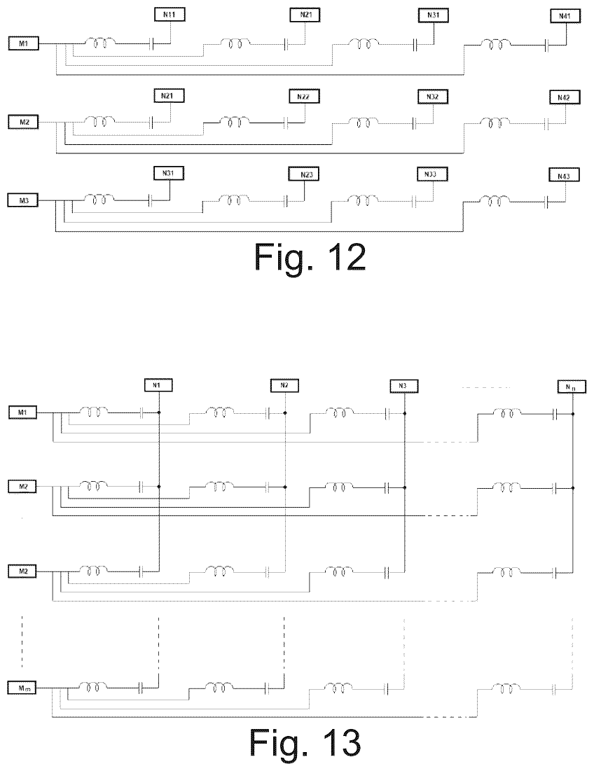

The architecture of FIG. 9 can be expanded by obtaining a multi-stage inverter as in FIG. 12, where the blocks M and N represent respectively master half bridge switching stages (M1, M2, M3) and slave half bridge switching stages (N11, . . . , N43). For example, it could be possible to have a system with three masters, each of which with four coils and therefore four slave half-bridges, all connected to the same DC BUS. In this case, a system with 12 coils is obtained. The number of converters and coils depends on:
the final dimensions of the product;
   the maximum power limitations of the individual inverters;
   the power limitations of the electrical network.

The method of this disclosure may be also used to control this multi-stage inverter for providing an almost null output power to the supplied L-C load whilst keeping all switches in soft switching mode.

The architecture of FIG. 12 can be modified as shown in FIG. 13 to supply a plurality of L-C load(s) organized in a matrix structure, where the blocks M and N are half-bridge stages, as in FIG. 12. For example, if there is a unique DC bus as in the inverter of FIG. 9, it could be possible to have a matrix architecture connected to the DC bus, with m master half-bridges M1, . . . , Mm, each of which having an intermediate node, between the respective high-side switch and the low-side switch, connected to n loads and therefore n slave half-bridges N1, . . . , Nn. In this case, an architecture capable of powering M×N loads is obtained.

According to the method of this disclosure, it is possible to control the output power delivered to each supplied load by adjusting at the same time the phase-shift PS of each master-slave (M−N) pair and their switching frequency. Conveniently, the switching frequency will be adjusted for all activated switches at the same time, to prevent audible noise.

In cases where more than one DC BUS is present, it is also possible to connect groups of the matrix described to each DC BUS. As in the previous case, the number of converters and coils depends on:
the final dimensions of the product;
the maximum power limitations of each single half-bridge;
the power limitations of the electrical network.

All the operating modes described can be used in combination to optimize power management.

It will be understood by one having ordinary skill in the art that construction of the described disclosure and other components is not limited to any specific material. Other exemplary embodiments of the disclosure disclosed herein may be formed from a wide variety of materials, unless described otherwise herein.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A method of controlling an induction hob, comprising:
operating a switching converter within the induction hob, the switching converter including:
a plurality of half-bridge switching stages, connected electrically in parallel between a high-side line and a low-side line of a direct-current voltage supply within the switching converter, each half-bridge switching stage of the plurality of half-bridge switching stages comprising a respective high-side controlled switch and low-side controlled switch connected in series between them and sharing an intermediate current terminal of the half-bridge switching stage; and
at least a first L-C resonant pair connected between two intermediate current terminals of two half-bridge switching stages of the plurality of half-bridge switching stages, wherein the first L-C resonant pair is configured to be magnetically coupled with a respective load, thereby defining at least a first equivalent resonant load (R-L-C);
wherein operating the switching converter includes operating a first of the plurality of half-bridge switching stages as a master half-bridge switching stage and operating at least a second of the plurality half-bridge switching stages as a first slave half-bridge switching stage, the controlled switches of the half-bridge switching stages being turned on and off during switching periods by means of respective periodic pulse-width modulation control signals; and
wherein a first L-C resonant pair of the at least one L-C resonant pair is connectable between the intermediate current terminal of the master half-bridge switching stage and the intermediate current terminal of the first slave half-bridge switching stage, and wherein the first L-C resonant pair of the at least one L-C resonant pair being magnetically coupled with a first respective load, thereby defining a first resonant load (RLC1) of the at least one resonant load (RLC); and
regulating a requested output power to be delivered to the at least a first resonant load with a first nominal reference value, including adjusting a common switching frequency of all the pulse-width modulation control signals and a phase displacement of at least one of the pulse-width modulation control signals, wherein adjusting the phase displacement is carried out by adjusting a time delay between, respective, turning-on instants of the high-side switches and the low-side switches of the master half-bridge switching stage and the low-side switches and the high-side switches of the slave half-bridge switching stage configured to supply the first resonant load within the switching periods, adjusting the phase displacement being further carried out in a range between 0° and 180°, until hard-switching working conditions for the half-bridge switching stages are met, and, when the hard-switching working conditions are met, the common switching frequency of all the pulse-width modulation control signals being further adjusted to prevent the hard-switching working conditions.

2. The method of claim 1, wherein the switching converter is operated using a control unit in electronic communication with the controlled switches.

3. The method of claim 1, wherein the switching converter further includes a rectifier stage having input AC terminals, for receiving an AC voltage to be rectified, and a DC-bus having a high-side line and a low side line for making available a DC voltage on the DC-bus between the high-side line and the low-side line.

4. The method of claim 1, wherein the adjusting the phase displacement includes mapping levels of the requested output power as a function of the phase displacement and of the common switching frequency about the first nominal reference power value, thereby defining an operating phase range, and wherein the adjustment step includes changing the phase displacement within the operating phase range with a variation step in a range between 0.1° and 5°.

5. The method of claim 4, wherein the operating phase range is determined based upon the resonant load and is stored in a memory unit, and wherein the operating phase range is determined using, as entries for the lookup table, the requested output power to be delivered to the equivalent resonant load (R-L-C) and the electrical parameters of the equivalent resonant load (R-L-C).

6. The method of claim 5, wherein the memory unit includes a lookup table.

7. The method of claim 1, wherein the adjusting the phase displacement includes mapping levels of the requested output power as a function of the phase displacement and of the common switching frequency about the first nominal reference power value, thereby defining an operating phase range, and wherein the adjustment step includes changing the phase displacement within the operating phase range by a variation step of about 2°.

8. The method of claim 1, wherein adjusting the common switching frequency of all the pulse-width modulation control signals results in modifying the common switching frequency of all the pulse-width modulation control signals by between about 200 and 300 Hz.

9. The method of claim 1, wherein when the first nominal reference value is lower than a first predetermined power level, the method further comprising:
energizing the first resonant load (RLC1) only by operating the master half-bridge switching stage, and wherein the high-side controlled switch of the first slave half-bridge switching stage is maintained off during the switching periods, and wherein the low-side controlled switch of the first slave half-bridge switching stage is maintained on during the switching periods.

10. The method of claim 1, wherein:
wherein operating the switching converter further includes operating a third half-bridge switching stage of the plurality of half-bridge switching stages as a second slave half-bridge switching stage;
the switching converter further includes a second L-C resonant pair of the at least one L-C resonant pair connected between the intermediate current terminal of the master half-bridge switching stage and the intermediate current terminal of the second slave half-bridge switching stage, the second L-C resonant pair of the at least one L-C resonant pair being configured to be magnetically coupled with a second respective load, thereby defining a second equivalent resonant load (R-L-C-2);
regulating the requested output power further includes:
regulating the requested output power to be delivered the second resonant load to a second nominal reference value;
adjusting the common switching frequency of all the pulse-width modulation control signals and the phase displacement of at least one of the pulse-width modulation control signals, wherein the step of adjusting the phase displacement is carried out by adjusting a time delay between respective turning-on instants of the high-side and the low-side switches of the master half-bridge switching stage and the low-side and high-side switches of at least one of the slave half-bridge stages configured to supply the resonant loads, within the switching period;
adjusting the phase displacement is carried out until hard-switching working conditions for at least one of the half-bridge switching stages are met, and wherein, when the hard switching working conditions are met the method further comprises the step of adjusting the common switching frequency of the PWM control signals to prevent the hard-switching working conditions.

11. The method of claim 10, wherein operating the switching converter includes operating the master half-bridge switching stage to simultaneously energize the first resonant load (R-L-C-1) and the second resonant load (R-L-C-2).

12. The method of claim 10, wherein when one of the first nominal reference value or the second nominal reference value is set equal to the other of the second or to the first nominal reference value, and the other of the first or second nominal reference value is lower than a first predetermined power level, the master half-bridge switching stage is not operated, and the first resonant load (R-L-C-1) and the second resonant load (R-L-C-2) are energized simultaneously by operating the first slave half-bridge switching stage and the second slave half-bridge switching stage, such that the first slave half-bridge switching stage is operated as the master half-bridge switching stage and the second slave half-bridge switching stage is operated as the first slave half-bridge switching stage.

13. The method of claim 10, wherein:
when the first nominal reference value and the second nominal value are set equal to each other, and are lower than a second predetermined power level, the resonant loads (R-L-C-1, R-L-C-2) are energized only by operating the master half-bridge switching stage;
the high-side controlled switches of the first and second slave half-bridge switching stages are maintained off during the switching periods; and
wherein the low-side controlled switches of the first and second slave half-bridge switching stages are maintained on during the switching periods.

14. The method of claim 13, wherein the first predetermined power level and the second predetermined power level are lower than 900 W, the first predetermined power level being equal to the second predetermined power level.

15. An induction hob comprising:
a switching converter, including:
a rectifier stage having input AC terminals for receiving an AC voltage to be rectified and a DC-bus having a high-side line and a low side line for making available a DC voltage on the DC-bus between the high-side line and the low-side line;
a plurality of half-bridge switching stages connected electrically in parallel between the high-side line and the low-side line, each half-bridge switching stage of the plurality of half-bridge switching stages comprising a respective high-side controlled switch and low-side controlled switch connected in series therebetween and sharing an intermediate current terminal of the half-bridge switching stage, the plurality of half-bridge switching stages including at least a master half-bridge switching stage and a first slave half-bridge switching stage;
at least a first L-C resonant pair connected between two intermediate current terminals of two half-bridge switching stages of the plurality of half-bridge switching stages, the first L-C resonant pair being configured to be magnetically coupled with a respective load, thereby defining at least a first resonant load (R-L-C); and
a control unit:
operating the switching converter by turning on and off the controlled switches of the half-bridge switching stages during switching periods by means of respective periodic pulse-width modulation control signals; and
regulating a requested output power to be delivered to the at least a first resonant load with a first nominal reference value, including adjusting a common switching frequency of all the pulse-width modulation control signals and a phase displacement of at least one of the pulse-width modulation control signals, wherein adjusting the phase displacement is carried out by adjusting a time delay between, respective, turning-on instants of the high-side switches and the low-side switches of the master half-bridge switching stage and the low-side switches and the high-side switches of the slave half-bridge switching stage configured to supply the first resonant load within the switching periods, adjusting the phase displacement being further carried out in a range between 0° and 180°, until hard-switching working conditions for the half-bridge switching stages are met, and, when the hard-switching working conditions are met, the common switching frequency of all the pulse-width modulation control signals being further adjusted to prevent the hard-switching working conditions.

16. The induction hob of claim 15, wherein the switching converter includes a plurality of modules, each module having a master half-bridge switching stage and at least one slave half-bridge switching stage, wherein the control unit is configured to operate the half-bridge switching stages of each module.

17. The induction hob of claim 15, wherein:
the master half bridge switching stage and the at least one slave half bridge switching stages are provided with solid state switches as high-side controlled switches and low-side controlled switches; and
a power rating of the solid-state switches belonging to the master half bridge switching stage is higher than a power rating of the solid state switches belonging to the at least one slave half bridge switching stage.

18. The induction hob of claim 17, wherein the solid-state switches are insulated-gate bipolar transistors.

19. The induction hob of claim 17, wherein:
the switching converter further includes a second L-C resonant pair of the at least one L-C resonant pair connected between the intermediate current terminal of the master half-bridge switching stage and the intermediate current terminal of a third half-bridge switching stage, the second L-C resonant pair of the at least one L-C resonant pair being configured to be magnetically coupled with a second respective load, thereby defining a second equivalent resonant load (R-L-C-2);
operating the switching converter further includes operating the third half-bridge switching stage of the plurality of half-bridge switching stages as a second slave half-bridge switching stage; and
regulating the requested output power further includes:
regulating the requested output power to be delivered the second resonant load to a second nominal reference value;
adjusting the common switching frequency of all the pulse-width modulation control signals and the phase displacement of at least one of the pulse-width modulation control signals, wherein the step of adjusting the phase displacement is carried out by adjusting a time delay between respective turning-on instants of the high-side and the low-side switches of the master half-bridge switching stage and the low-side and high-side switches of at least one of the slave half-bridge stages configured to supply the resonant loads, within the switching period;
adjusting the phase displacement is carried out until hard-switching working conditions for at least one of the half-bridge switching stages are met, and wherein, when the hard switching working conditions are met the method further comprises the step of adjusting the common switching frequency of the PWM control signals to prevent the hard-switching working conditions.

20. The induction hob of claim 19, wherein operating the switching converter includes operating the master half-bridge switching stage to simultaneously energize the first resonant load (R-L-C-1) and the second resonant load (R-L-C-2).
